(19) United States
(12) Patent Application Publication
(10) Pub. No.: US 2013/0206664 A1
(43) Pub. Date: Aug. 15, 2013

(54) METAL ION STERILIZATION DEVICE

(71) Applicant: Tae Gyo Kim, Gangwon-do (KR)

(72) Inventor: Tae Gyo Kim, Gangwon-do (KR)

(21) Appl. No.: 13/880,761

(22) PCT Filed: Aug. 19, 2011
(86) PCT No.: PCT/KR11/06154

§ 371 Date: Apr. 22, 2013

(30) Foreign Application Priority Data
Oct. 22, 2010 (KR) 10-2010-0103319
May 6, 2011 (KR) 10-2011-0042875
Jun. 24, 2011 (KR) 10-2011-0061656
Jul. 21, 2011 (KR) 10-2011-0072258
Aug. 19, 2011 (KR) PCT/KR2011/006154

(51) Int. Cl. C02F 1/467

(52) U.S. Cl. CPC C02F 1/467
USPC 210/192

(57) ABSTRACT

The present invention relates to a metal ion sterilization device. The metal ion sterilization device of the present invention includes: a chamber having a channel through which water passes; a first electrode which is installed on the channel of the chamber to receive an external voltage, and which has a cone shape, the diameter of which is progressively reduced in the downward direction; an insulation holder which has an extended cone shape to enable the first electrode to be inserted and received inside same, and one side of which is connected to a driving source so as to be rotated; and a second electrode which has an extended cone shape to enable the insulation holder to be inserted and received inside same, and which receives an external voltage opposite that of the first electrode.

### CROSS-REFERENCE TO RELATED APPLICATION

This application claims the benefit of Korean Patent Application No. 10-2010-0103319, filed on Oct. 22, 2010 and Korean Patent Application No. 10-2011-0042875, filed on May 6, 2011 and Korean Patent Application No. 10-2011-0061656, filed on Jun. 24, 2011 and Korean Patent Application No. 10-2011-0072258, filed on Jul. 21, 2011 in the Korean Intellectual Property Office, the disclosure of which is incorporated herein by reference.

### TECHNICAL FIELD

The present invention relates to a sterilization device which improves the quality of water using metal ions, and more particularly, to a metal ion sterilization device in which the distances between electrodes are maintained to be constant when the electrodes are worn so that reliable ionization performance is realized and the structure of the device is simplified so that it is economically fabricated and the degree of the freedom of a space where it is to be installed is increased.

### BACKGROUND ART

In general, all potable water, food processing water, commercial water used in buildings, swimming pools or so on and water used in farming, stock breeding and fisheries are subjected to a predetermined sterilization process before being used. Recently, in order to overcome the problem of the input of chemicals, a sterilization method using metal ions, which was used by NASA in 1970s as a method of cleaning potable water in a spacecraft, is gaining interest. This sterilization method using metal ions uses sterilization power of Cu and Ag from among various metals. In this method, electrodes (specially manufactured) made of an alloy of Ag and Cu are disposed in a chamber, and when a direct current is applied to the electrodes, the Ag—Cu alloy in the electrodes is ionized such that ions are dissolved into water. The dissolved Cu and Ag ions neutralize the enzyme that metabolizes bacteria, and the anode electrical load of Cu and Ag ions destroys bacteria, including their protoplasm. That is, metal ions of Ag or Cu are dissolved into water, or an object to be cleaned, so that the sterilization power of metal ions acts. This method has characteristics, such as long lasting effect of sterilization, unchanging sterilization power when mixed with other materials, applicability of large water treatment facilities, tastelessness, odorlessness, nontoxicity, economic installation and inexpensive maintenance, not causing pipes to corrode, perfect sterilization of about 650 species such as bacteria and molds, ability to prevent the tolerance of bacteria, the property of not evaporating when heated and so on. Accordingly, this method is gradually becoming more popular as a substitution for a traditional ultraviolet (UV) sterilization or chlorination method. However, a device using such metal ions is based on the principle that positive (+) and negative (−) electrodes are made of metal and a current is flown through the electrodes so that metal ions are dissolved into water, the electrodes are gradually worn by repeated sterilization. The positive (+) and negative (−) electrodes are gradually more distanced from each other. Then, it does not take long until the electrodes become non-functional, which is disadvantageous. In addition, since the concentration of ions gradually decreases, it must be artificially compensated for, and sterilization power is decreased due to the unbalance of ions, which is problematic.

In order to overcome the foregoing problems with the related art, the applicant made a metal ion sterilization device having improved automatic control function for ionization, which was registered as Korean Patent No. 10-0768095. The metal ion sterilization device which was previously filed by the applicant includes a chamber having a channel through which water passes. Conical first and second electrodes are symmetrically disposed in the channel of the chamber, adjacent to each other. The first and second electrodes are respectively applied with positive and negative voltages. A conical holder supports one of the first and second electrodes so as to slide in the weight direction. Rotating means rotate the first and second electrodes.

However, in the metal ion sterilization device of the related art, since the conical first and second electrodes are symmetrically disposed, only a part of the circumference of each electrode faces the counterpart electrode. This consequently leads to the low ionization ratio and the bulky size compared to the performance, which is problematic. In particular, when the (+) electrode and the (−) electrode are exchanged, nanoscale particles due to ion exchange are attached to the first and second electrode, thereby making it difficult to realize reliable performance. In order to overcome this, it is required to disassemble the device, clean the electrodes, and then assemble the device again. This consequently increases the difficulty of maintenance and the relevant cost, which is problematic.

### DISCLOSURE

### Technical Problem

The present invention has been made to solve the foregoing problems with the related art, the invention is intended to minimize the volume by simplifying the structure while maximizing the areas of first and second electrodes which face each other, thereby maximizing ionization performance and increasing the ease of maintenance. The invention is also intended to maintain the distance between electrodes to be uniform when the electrodes have been worn, thereby increasing the lifespan of the electrodes, and to prevent nanoparticles that are attached to the electrodes during ionization, thereby preventing the performance from deteriorating. Furthermore, the invention is also intended to provide a metal ion sterilization device in which the efficiencies of ionization and mixing are maximized by enabling an insulator to rotated by the pressure of inflow water, and the degree of design freedom is increased by simplifying the structure, so that constrains pertaining to the installation space are reduced and high-efficient performance is realized.

### Technical Solution

In order to realize the foregoing object, provided is a metal ion sterilization device according to a first embodiment of the invention. The metal ion sterilization device includes a chamber having a channel through which water passes; a conical first electrode disposed in the channel of the chamber to receive an external voltage, with a diameter thereof gradually decreasing in a direction from top to bottom; an insulation holder having an expanded conical shape to enable the first electrode to be inserted and held therein, one portion of the insulation holder being connected to a driving source so as to be rotatable; and a second electrode having an expanded conical shape to enable the insulation holder to be inserted and held therein, the second electrode receiving an external voltage having a polarity opposite to a polarity of the first electrode.

In order to realize the foregoing object, also provided is a metal ion sterilization device according to a second embodiment of the invention which generates ionized water by dissolving metal ions into water supplied from the outside. The metal ion sterilization device includes: a chamber having an inlet pipe and an outlet pipe; a conical first electrode disposed inside the chamber to receive an external voltage, with a diameter thereof gradually decreasing in a direction from top to bottom, a portion of an upper part of the first electrode being supported by a portion of an inner part of the chamber; an insulation holder having an expanded conical shape such that the first electrode is inserted and held therein, and is rotatable; a second electrode having an expanded conical shape such that the insulation holder is inserted and held therein, the second electrode receiving an external voltage having a polarity opposite to a polarity of the first electrode; and a vortex driving source connected to a portion of the lower part of the insulation holder to rotatably support the insulation holder, the vortex driving source being rotated by the water that is introduced thereto.

In order to realize the foregoing object, also provided is a metal ion sterilization device according to a second embodiment of the invention which generates ionized water by dissolving metal ions into water supplied from an outside, in which a pair of electrodes are disposed on both sides of an insulator. The metal ion sterilization device includes: a chamber having an inlet pipe and an outlet pipe; an insulation mill disposed inside the chamber to be rotated by the water that is introduced thereto, the insulation mill having a hollow tubular shape, having both open sides, and being made of an insulating material, and including a plurality of blades provided on a circumference thereof and water passage holes; and the first and second electrodes being fixedly provided on both sides of the insulation mill, having a shape of a disk, and receiving different voltages from an outside.

### Advantageous Effects

In the metal ion sterilization device according to the first embodiment of the invention, the first and second electrodes are stacked such that they concentrically overlap each other. It is possible to minimize the occupancy of spaces and maximize the areas of the electrodes that face each other in order to maximize the ionization performance, thereby increasing the sterilization efficiency, which is advantageous. In addition, when the electrodes are worn due to the ionization of metal, the first electrode moves down by the weight while maintaining the uniform distance to the second electrode, so that reliable and continuous sterilization is possible until the electrodes are completely worn. According to the construction in which the brushes are integrally provided on the insulation holder disposed between the first and second electrodes, it is possible to remove nanoparticles that are attached to the electrodes during the ionization, thereby realizing and maintaining the performance of reliably generating ions. Therefore, this has the useful effects of increasing the ease of use and the reliability of the product. Furthermore, since the vortex guide slots are formed in the insulating holder, the effective ionization ratio for inflow water can be obtained. Accordingly, the effect of improving the performance is expected.

In the metal ion sterilization device according to the second embodiment of the invention, it is possible to easily mix metal ions and water using the vortex-creating element which does not need a separate driving source. In addition, it is possible to obtain the effective ionization ratio for the inflow water by forming the vortex guide slots in the first and second electrodes and the insulation holder. Accordingly, the effect of improving the performance is expected.

In the metal ion sterilization device according to the third embodiment of the invention, the first and second electrodes having the shape of a disk are disposed on both sides of the insulator which rotates like a water mill. It is possible to maximize the contact area between the electrodes while minimizing the occupancy of spaces compared to the related art. Accordingly, the useful effects of increasing the ionization efficiency and improving the performance of the device and the sterilization performance are expected.

### DESCRIPTION OF DRAWINGS

FIG. 1 and FIG. 2 are perspective views depicting a metal ion sterilization device according to a first embodiment of the invention;

FIG. 3 to FIG. 6 are exploded perspective views showing modified embodiments of FIG. 1;

FIG. 7 to FIG. 9 are views depicting a metal ion sterilization device according to a second embodiment of the invention;

FIG. 10 to FIG. 14 are views showing several modified embodiments of FIG. 7;

FIG. 15 to FIG. 17 are views depicting a metal ion sterilization device according to a third embodiment of the invention; and

FIG. 18 to FIG. 22 are views showing several modified embodiments of FIG. 15.

### MODE FOR INVENTION

Reference will now be made in detail to a metal ion sterilization device according to the present invention, embodiments of which are illustrated in the accompanying drawings and described below. Throughout this document, reference should be made to the drawings, in which the same reference numerals and signs are used throughout the different drawings to designate the same or similar components. In the following description of the present invention, detailed descriptions of known functions and components incorporated herein will be omitted when they may make the subject matter of the present invention unclear.

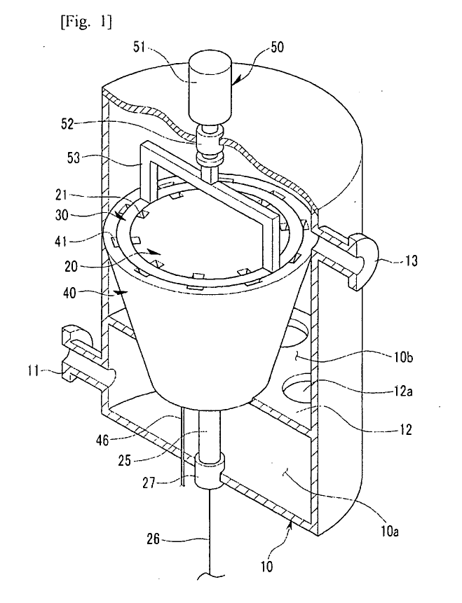

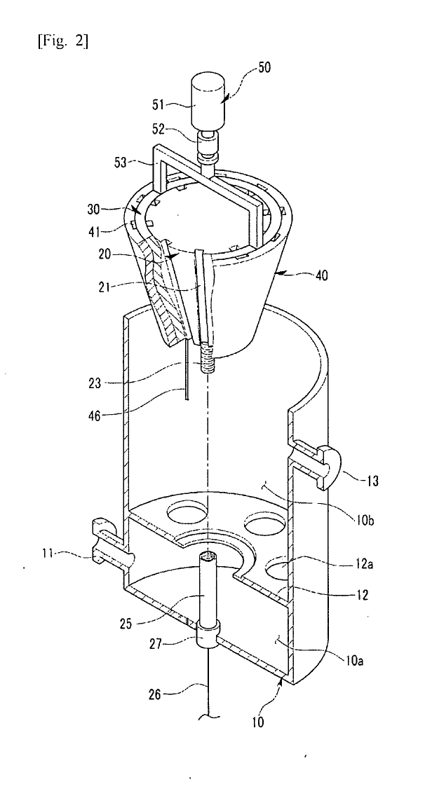

FIG. 1 is a perspective view depicting the overall configuration of a metal ion sterilization device according to a first embodiment of the invention, in which a chamber is partially cut away, and FIG. 2 is an exploded perspective view of the same.

As shown in the figures, the metal ion sterilization device 1 according to the invention includes a chamber 10 having a channel in which water introduced from the outside contains metal ions therein and through which the water flows to the outside; a conical first electrode 20 which is disposed in the channel of the chamber 10 to receive an external voltage, with the diameter thereof gradually decreasing in the direction from top to bottom; an insulation holder 30 which has an expanded conical shape such that the first electrode 20 can be inserted and held therein, has open upper and lower portions, and receives an external rotational driving force; a second electrode 40 which has an expanded conical shape such that the insulation holder 30 can be inserted and held therein, has open upper and lower portions, and receives an external voltage having a polarity opposite to a polarity of the first electrode 20; and a driving source 50 which is disposed outside the chamber 10, generates the rotational driving force, and supplies the rotational driving force to the insulation holder 30 inside the chamber 10.

As shown in the figures, the chamber 10 is a hollow tubular member, and has an inlet pipe 11 in the lower portion thereof through which the water can be introduced and an outlet pipe 13 in the upper portion thereof through which the introduced water can be discharged to the outside. In addition, a driving motor 51 of the driving source 50 is fixedly disposed outside and above the chamber 10, and a rotary shaft 51S of the driving motor 51 extends into the chamber 10. The inner space of the chamber 10 is divided into the lower space 10a and the upper space 10b, and according to the invention, a partition plate 12 is provided for this purpose. The partition plate 12 is disposed in the lateral direction so as to divide the space. The partition plate 12 has one or more through-holes 12a through which the water, which is introduced into the lower space 10a through the inlet pipe 11, can flow toward the upper space 10b. Although not shown in the figures, when the chamber 10 having this configuration is positioned on the ground, a leg frame is added to the chamber. In addition, it is preferred that the chamber be made of a corrosion resistant material, such as a synthetic resin, a stainless metal, or the like.

The first electrode 20 has the conical shape, with the diameter thereof gradually decreasing in the direction from top to bottom, and can be molded from an alloy that contains at least one selected from among Cu, Ag and Al. That is, the first electrode 20 is configured such that electric power is applied thereto. For this purpose, the invention proposes a configuration in which a fastening portion 23 is formed on the lower surface of the first electrode 20 and an electric cord 26 is disposed inside a support post 25, which will be described later, and is connected to the fastening portion 23.

As shown in the figures, the support post 25 is a hollow shaft, which has a spiral formed in the upper inner circumference thereof such that the fastening portion 23 can be inserted and screwed thereinto. One end of the support post extends through the bottom plate of the chamber 10 so as to be exposed to the outside. In addition, one end portion of the support post 25 which passes through the bottom plate of the chamber 10 is surrounded and supported by a known post waterproof seal 27, such that the support post 25 is displaceable in the top-bottom direction. The post waterproof seal 27 is a mechanical seal which prevents leakage through a gap between the bottom plate of the chamber 10 and the support post 25 which extends through the chamber 10, and may be implemented by a well-known technique. Describing the schematic configuration, the post waterproof seal 27 includes an outer tube, an inner tube which is slid into the outer tube such that it can displace, and a sealer configured as a ring or thin film which seals the gap between the inner and outer tubes to be watertight. In addition, the first electrode 20 according to the invention has first water flow guide grooves 21 in the outer surface thereof. The flow guide grooves 21 extend in the lengthwise direction of the first electrode 20, and are arranged at regular distances from each other, such that the water can efficiently flow in between the first electrode 20 and the second electrode 40, which will be described later. Here, the first water guide grooves 21 are formed to be linear. When the first electrode 20 having the above-described configuration has been worn and abraded, the electrode is forced to move down in the weight direction along the smooth surface of the insulation holder 30, which will be described later. Here, since the support post 25 which supports the first electrode 20 is configured such that it is displaceable in the top-bottom direction by the post waterproof seal 27, the first electrode 20 and the support post 25 naturally descend as much as the amount of the electrode that has been worn, so that a uniform gap to the second electrode 40, which will be described later, can be maintained.

As shown in the figures, the insulation holder 30 has the conical shape such that it can hold the first electrode 20 therein, with the upper and lower portions thereof being open. The insulation holder 30 prevents the first and second electrodes 20 and 40 from coming into direct contact with each other while guiding the first electrode 20 to naturally descend as much as the amount of the electrode that has been worn. In addition, the insulation holder 30 according to the invention is provided as Teflon or an insulating material coated with Teflon. Herein, Teflon indicates a high-molecular compound referred to as a fluorine resin, and is a polymer of unit components which include major components of fluorine, carbon and hydrogen form. The insulation holder 30 according to the invention can be provided by molding from such a Teflon material, or by forming an insulation holder from an insulating material and then forming a film on its surface using a fluorine resin as a paint. The insulation holder 30 having the above-described configuration has water flow guide slots 31 which are elongated in the top-bottom direction such that the water in the lower space 10a can efficiently flow in between the first and second electrodes 20 and 40. The water flow guide slots 31 are configured such that they are radially disposed about the lower part of the insulation holder 30.

The second electrode 40 is a conical member which has the expanded size such that the insulation holder 30 can be inserted and held therein, and has the open upper and lower portions. An electric cord 46 which applies an external voltage having a polarity opposite to that of the voltage supplied to the first electrode 20 is distributed to the second electrode 40. Specifically, the second electrode 40 has the conical shape with the diameter thereof gradually decreasing in the direction from top to bottom, as well as a tubular shape having the open upper and lower portions, and is configured such that the lower portion is seated on a stepped seating portion (no reference numeral) which has an installation hole formed at the center of the partition plate 12. The second electrode 40 can be coupled to the partition plate 12 via welding, a mechanical fitting structure, or a separate fitting device such that it is prevented from moving. Since this can be easily realized by a well-known technique, a detailed description thereof will be omitted. In addition, like the first electrode 20, the second electrode 40 is molded from an alloy that contains at least one selected from among Cu, Ag and Al, and the electric cord 46 through which a voltage is applied from the outside is distributed to the lower portion. In addition, the second electrodes 40 has second water flow guide grooves 41 in the inner surface thereof. The second water flow guide grooves 41 extend in the lengthwise direction and are arranged at regular distances from each other, such that the water that is supplied to the lower space 10a can efficiently flow in between the first and second electrodes 20 and 40. The second electrode 40 having this configuration is disposed such that the second electrode 40 and the first electrode 20 are concentric with each other, on both sides of the insulation holder 30, which is rotated by the driving source 50. Consequently, the first and second electrodes 20 and 40 are uniformly worn by the rotation of the insulation holder 30.

The driving source 50 includes a driving element which generates the rotational driving force for rotating the insulation holder 30 and a transmitting element which transmits the driving force to the insulation holder 30. According to the invention, the driving motor 51, which is supplied with power from the outside and rotates the rotary shaft 51s, is proposed as the driving element of the driving source 50. A link body 53 is proposed as the transmitting element of the driving source 50. One end of the link body 53 is connected to the rotary shaft 51s of the driving motor 51, and the other end of the link body 53 is divided into two or more branches, which are connected to the upper portion of the insulation holder 30.

The driving motor 51 is a driving element which is provided outside and above the chamber 10 and generates the rotational driving force by receiving power. Although not shown, one portion of the driving motor 51 is supported by one portion of the chamber 10 such that it can have a displacement in the top-bottom direction while cooperating with the insulation holder 30 as an integral part. Since the top-bottom displacement structure of the driving motor 51 may be realized by a well-known technique, a detailed description thereof will be omitted. In the meantime, one end of the rotary shaft 51s of the driving motor 51 is positioned inside the upper space 10b through the upper plate of the chamber 10. The portion of the rotary shaft 51s adjacent to one end that extends through the upper plate of the chamber 10 is supported by a motor waterproof seal 52. Like the above-described post waterproof seal 27, the motor waterproof seal 52 is a mechanical seal element which is supported such that it can be displaced in the axial direction while preventing leakage through a gap. Since this element is realized by a well-known technology, a detailed description thereof will be omitted.

The link body 53 is devised such that it transmits the rotational driving force of the rotary shaft 51s to the insulation holder 30. One end of the link body 53 is connected to the distal end of the rotary shaft 51s, and the other end of the link body 53 is divided into two or more branches, which are connected to the upper peripheries of the insulation holder 30.

A description will be given below of the operation of the metal ion sterilization device having the above-described configuration according to the invention. First, when high-pressure water is introduced into the chamber 10 through the inlet pipe 11, the introduced water fills up the lower space 10a of the chamber 10. At the same time, part of the water flows to the upper space 10b through the through-holes 12a of the partition plate 12, whereas part of the water flows through the gap between the first and second electrodes 20 and 40. At this time, the first electrode 20, the second electrode 40 and the insulation holder 30 have the first water flow guide grooves 21, the second water flow guide grooves 41 and the water flow guide slots 31, such that the water can efficiently flow in. Since the first and second electrodes 20 and 40 are applied with different polarity voltages and the insulation holder 30 is rotating in one direction under the rotational driving force of the driving source 50. The water that flows through the first and second electrodes 20 and 40 contains a large amount of metal ions. In an example, when the first electrode 20 is applied with positive (+) polarity and the second electrode 40 is applied with negative (−) polarity, ionization is carried out at the first electrode 20, or the positive (+) electrode. While metal ions ionized in this fashion are being dissolved toward the negative (−) electrode, they are dissolved into the water that flows between the first and second electrodes 20 and 40. Therefore, the water that has flown between the first and second electrodes 20 and 40 contains a large amount of metal ions. This water is mixed with the water that has flown through the through-holes 12a of the partition plate 12 before being discharged through the outlet pipe 13 to the outside. The first and second electrodes 20 and 40 are uniformly worn by the insulation holder 30 which is rotated by the driving source 50. In addition, when the first electrode 20 is worn, the support post 25 which supports the first electrode 20 is displaced in the top-bottom direction by the post waterproof seal 27. Also, in the insulation holder 30 which holds the first electrode 20, the rotary shaft 51s of the driving motor 51 is displaced in the top-bottom direction by the motor waterproof seal 52. Consequently, the first electrode 20 and the insulation holder 30 are displaced down so as to compensate for the gap as much as the amount of the electrodes that has been worn. It is therefore possible to maintain the uniform gap between the first and second electrodes 20 and 40 irrespective of the wear of the electrodes, thereby realizing the reliable ionization performance.

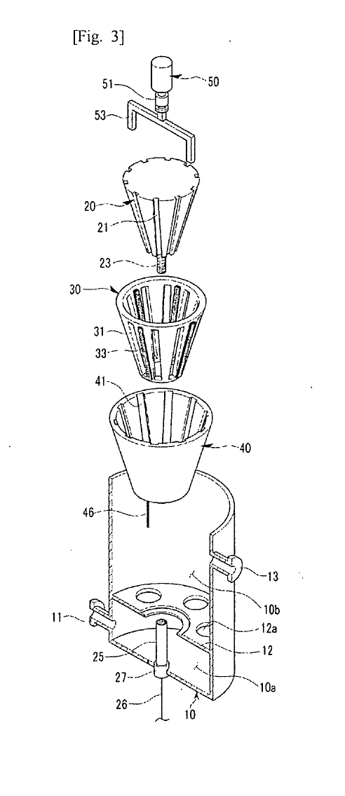

FIG. 3 is an exploded perspective view showing a modified embodiment of the metal ion sterilization device shown in FIG. 1. Since the metal ion sterilization device is substantially identical to the former metal ion sterilization device, the same components will be designated with the same reference numerals and descriptions thereof will be omitted. The technical features of this embodiment are to remove nanoparticles that are attached to the first and second electrodes 20 and 40 during the ionization process, thereby reliably maintaining the performance of generating ions while increasing the ease of maintenance and the reliability of the performance of products. For this, this embodiment proposes a construction in which brushes 33 are integrally provided in the insulation holder 30 disposed between the first and second electrodes 20 and 40. Each of the brushes 33 can be implemented by forming bristles from a synthetic resin or an insulating material or forming a synthetic resin or an insulating material in the shape of strips. In addition, the insulation holder 30 has brush holes (no reference numeral) at regular distances. The brush holes are formed at positions that do not interfere with the positions of the water flow guide slots 31, and the brushes 33 are fitted into the brush holes such that the brushes 33 can be securely mounted. The insulation holder 30 having the above-described configuration is rotated by receiving the driving force from the driving source 50. At this time, the brushes 33 provided in the insulation holder 30 rotate while abutting against the first and second electrodes 20 and 40, which are provided inside and outside the insulation holder 30, thereby removing the nanoparticles attached to the first and second electrodes 20 and 40. The function of the metal ion sterilization device according to this modified embodiment of the invention is substantially identical to that of the above-described former embodiment, and thus a detailed description thereof will be omitted.

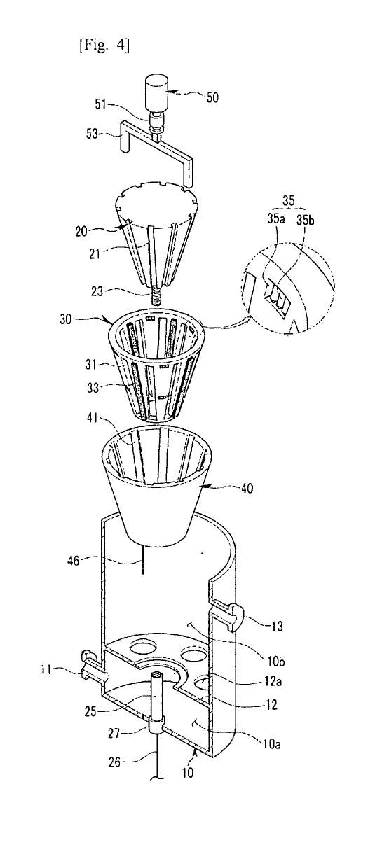

FIG. 4 is an exploded perspective view depicting the configuration of another modified embodiment of the metal ion sterilization device shown in FIG. 1. The technical features of this embodiment are to propose rolling elements 35 which are in rolling contact with the first and second electrodes 20 and 40 so that the insulation holder 30 which rotates by receiving the driving force from the driving source 50 efficiently rotates or has a proper displacement in the top-bottom direction with respect to the inside and outside electrodes. For this, this embodiment proposes a construction which has installation holes 35a, which are formed at positions that interfere with neither the water flow guide slots 31 nor the brushes 33, and rollers 35b, or the rolling elements, which are rotatably provided in the installation holes 35a. Here, the rollers 35b can be substituted with balls, or spheres, and can be disposed such that they roll with respect to the direction in which the insulation holder 30 rotates or with respect to the displacement of the first and second electrodes 20 and 40 in the top-bottom direction.

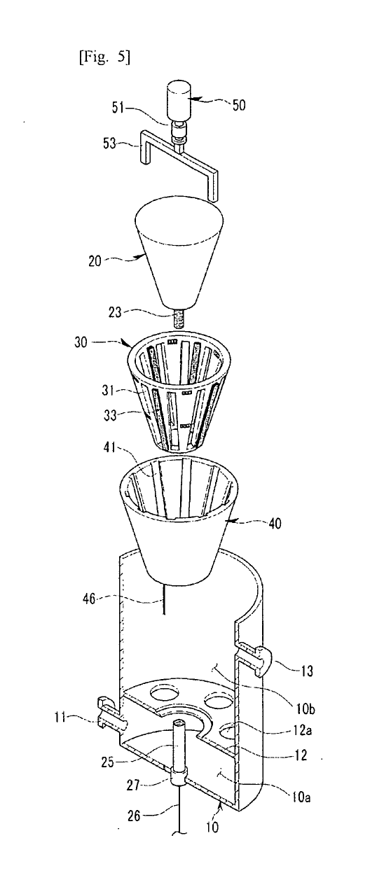

FIG. 5 shows a further modified embodiment of FIG. 1. The technical features of this embodiment are to propose a construction in which only the second water flow guide grooves 41 and the water flow guide slots 31 are formed in the second electrode 40 and the insulation holder 30 without the first water flow guide grooves 21 in the outer surface of the first electrode 20.

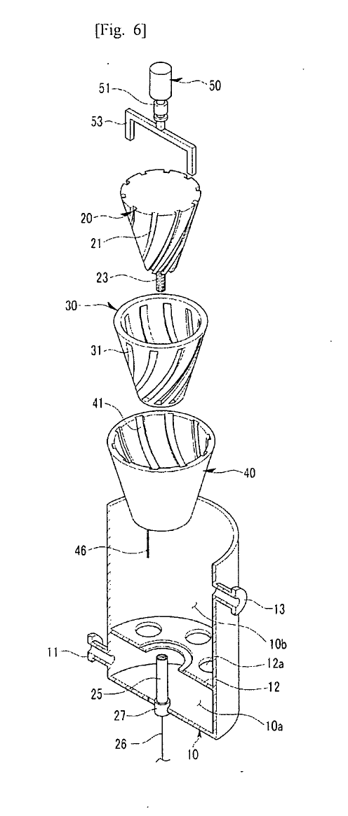

FIG. 6 shows further another modified embodiment of FIG. 1. According to the technical features of this embodiment, vortex elements are added. When the insulation holder 30 rotates, the vortex elements properly guide the water, which is supplied to the lower space 10a, between the first and second electrodes 20 and 40 so that the water is ionized, and cause the water, which has flown through the first and second electrodes 20 and 40, to create a vortex flow. Consequently, the water can be efficiently mixed with the water that has flown into the upper space 10b through the through-holes 12a of the partition plate 12. For this, according to this embodiment, the first water flow guide grooves 21, the second water flow guide grooves 41 and the water flow guide slots 31 have a spiral shape which can cause a vortex flow, unlike the linear shape of the former embodiments.

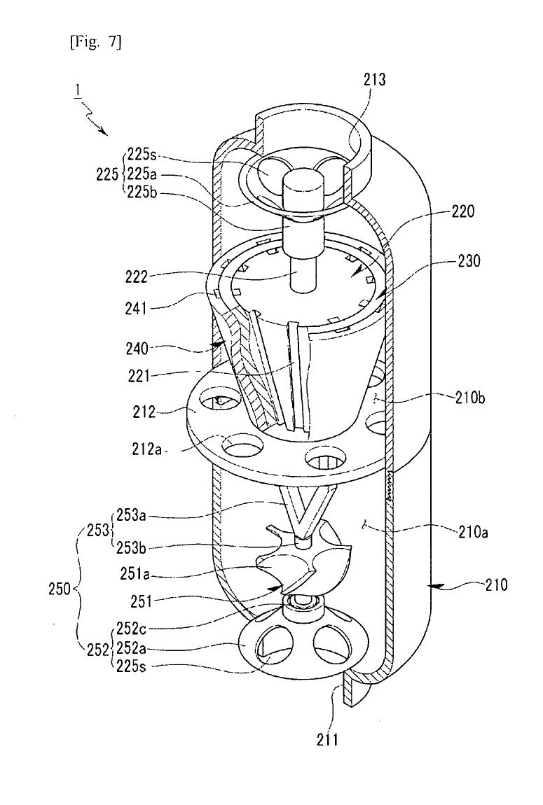

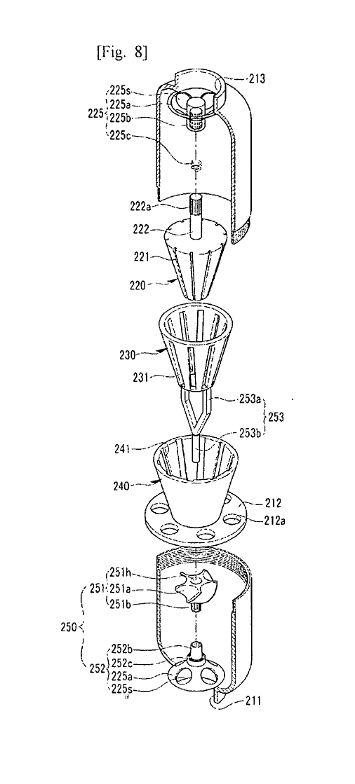

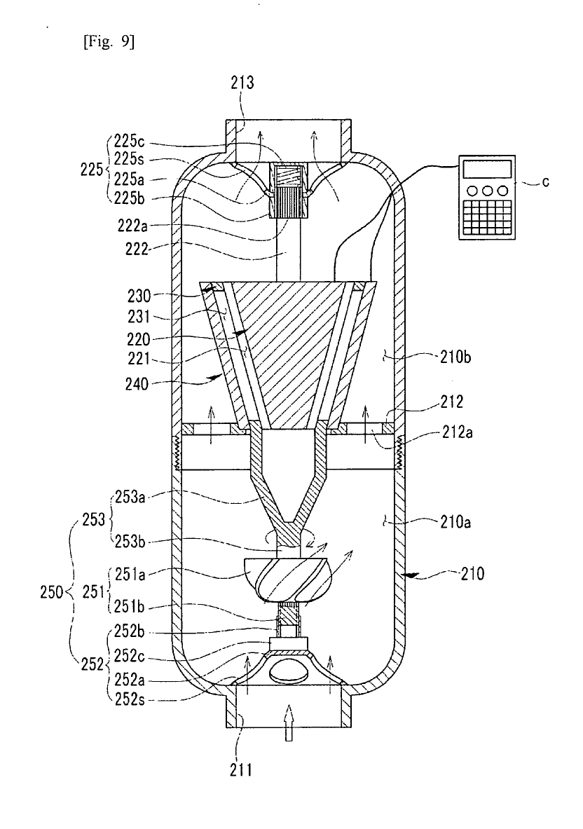

FIG. 7 and FIG. 8 are perspective views depicting a metal ion sterilization device according to a second embodiment of the invention, and FIG. 9 is a longitudinal cross-sectional view depicting the configuration of the metal ion sterilization device shown in FIG. 7. As shown in the figures, the metal ion sterilization device 1 according to the invention includes a chamber 210 having a channel in which water introduced from the outside contains metal ions therein and through which the water flows to the outside; a first electrode 220 which is disposed inside the chamber 210 to receive an external voltage, and has a conical shape, with a diameter thereof gradually decreasing in the direction from top to bottom; an insulation holder 230 which has an expanded conical shape such that the first electrode 220 can be inserted and held therein, has open upper and lower portions, and receives an external rotational driving force; and a second electrode 240 which has an expanded conical shape such that the insulation holder 230 can be inserted and held therein, has open upper and lower portions, and receives an external voltage having a polarity opposite to a polarity of the first electrode 220; and a vortex driving source 250 which is disposed in a lower space 210a of the chamber 210, generates a rotational driving force by receiving the water supplied from the outside, or inflow water, supplies the rotational driving force to the insulation holder 230, and causing a vortex flow in the inflow water.

As shown in the figures, the chamber 210 is a hollow tubular member, and has an inlet pipe 211 in the lower portion thereof through which the water can be introduced and an outlet pipe 213 in the upper portion thereof through which the introduced water can be discharged to the outside. Although the inlet pipe 211 and the outlet pipe 213 are illustrated as being formed at opposing positions in the upper and lower parts of the chamber 210, the positions can be variously modified as long as the water is introduced from the outside through the inlet pipe and the ionized water produced by dissolving ions into the inflow water is discharged through the outlet pipe to the outside. In addition, the inner space of the chamber 210 is divided into the lower space 210a and the upper space 210b, and according to the invention, a partition plate 212 is disposed for this purpose. The partition plate 212 is disposed in the lateral direction on the surface of the figure so as to divide the space. The partition plate 212 has one or more through-holes 212a through which the water, which is introduced into the lower space 210a through the inlet pipe 211, can flow toward the upper space 210b. Although not shown in the figures, when the chamber 210 having this configuration is positioned on the ground, a leg frame is added to the chamber. In addition, it is preferred that the chamber be made of a corrosion resistant material, such as a synthetic resin, a stainless metal, or the like.

The first electrode 220 has the conical shape, with the diameter thereof gradually decreasing in the direction from top to bottom, and can be molded from an alloy that contains at least one selected from among Cu, Ag and Al. Preferably, both of the first and second electrodes 220 and 240 can be molded from the same metal, or the first and second electrodes 220 and 240 can be molded from different metals. The first electrode 220 is configured such that electric power is applied thereto. As shown in FIG. 9, the invention illustrates a construction which is electrically connected via electric cords to a control panel C, which is provided outside the chamber 210. In addition, the first electrode 220 is provided such that it can have an elastic displacement in the top-bottom direction inside the chamber 210. Due to this, the gap to the second electrode 240, which will be described later, can be maintained uniform, such that ion can be reliably generated. Specifically, according to the invention, a support post 222 protrudes in the top-bottom direction from the upper central portion of the first electrode 220, and a concave-convex fitting portion 222a which includes a repetition of grooves and protrusions is formed on the upper outer circumference, or the distal end, of the support post 222. In addition, an electrode support 225 is provided having a shape which covers the outlet pipe 213 of the chamber 210. The electrode support 225 generally includes an electrode bracket 225a, an electrode sleeve 225b to which the support post 222 is fitted and assembled, and an elastic body 225c which applies an elastic supporting force with respect to the support post 222.

As shown in the figures, the peripheral surface of the electrode bracket 225a is fixedly bonded to the periphery of the outlet pipe 213 of the chamber 210 via welding, the electrode sleeve 225b integrally protrudes from the bottom of the electrode bracket 225a. Through-holes 225s are formed around the electrode sleeve 225b, and allow the water inside the chamber 210 to be discharged through the outlet pipe 213.

The electrode sleeve 225b is a tubular member which protrudes down in the top-bottom direction from the lower center of the electrode bracket 225a, and has a concave-convex structure in the inner circumference thereof such that the concave-convex portion 222a of the support post 222 can be assembled to the electrode sleeve 225b via fitting. This configuration prevents the electrode sleeve 225b and the support post 222 from externally rotating with respect to each other while allowing the same to be displaced in the top-bottom direction.

The elastic body 225c is an elastic element which is provided inside the electrode sleeve 225b, and according to the invention, is implemented as a coil spring. The elastic body 225c elastically supports the support post 222, which is fitted into and assembled to the electrode sleeve 225b, in the bottom direction, so that a uniform gap can be consequently maintained between the first electrode 220 and the second electrode 240. Due to this configuration, the first electrode 220 is elastically supported in the bottom direction, or the weight direction. Consequently, it is possible to compensate for the gap between the first and second electrodes 220 and 240 even though the wear of the electrodes has occurred, so that the gap can be maintained uniform irrespective of the wear of the electrodes, thereby maintaining ions to be uniformly generated. Specifically, when the first electrode 220 has been worn and abraded, the first electrode is forced to move down in the weight direction along the smooth surface of the insulation holder 230, which will be described later, while receiving the elastic supporting force from the elastic body 225c. Consequently, the first electrode 220 naturally moves down as much as the amount of the electrode that has been worn, so that the uniform gap to the second electrode 240, which will be described later, can be maintained. In addition, the first electrode 220 according to the invention has first water flow guide grooves 221 in the outer surface thereof. The water flow guide grooves 221 extend in the lengthwise direction, and are arranged at regular distances from each other, such that the water can efficiently flow in between the first electrode 220 and the second electrode 240, which will be described later. Here, the first water guide grooves 221 are formed to be linear.

The insulation holder 230 has the conical shape such that it can hold the first electrode 220 therein, with the upper and lower portions thereof being open. The insulation holder 230 is an insulating and guiding member which prevents the first and second electrodes 220 and 240 from coming into direct contact with each other while guiding the first electrode 220 to naturally move down as much as the amount of the electrode that has been worn. In addition, this insulation holder 230 is provided as Teflon or an insulating material coated with Teflon. Herein, Teflon indicates a high-molecular compound referred to as a fluorine resin, and is a polymer of unit components which include major components of fluorine, carbon and hydrogen form. The insulation holder 230 according to the invention can be provided by molding from such a Teflon material, or by forming an insulation holder from an insulating material, such as a synthetic resin or a ceramics, and then forming a film on its surface using a fluorine resin as a paint. It is preferred that the insulation holder have water flow guide slots 231 which are elongated in the top-bottom direction such that the water in the lower space 210a can efficiently flow in between the first and second electrodes 220 and 240, which will be described later. Here, the water flow guide slots 231 are configured such that they are radially disposed about the lower part of the insulation holder 230. The lower portion of the insulation holder 230 is connected to and supported by an insulating support 253 of the vortex driving source 250, which will be described later, such that the insulation holder 230 rotates in one direction in cooperation with the vortex driving source 250.

The second electrode 240 is a conical member which has the expanded size such that the insulation holder 230 can be inserted and held therein, and has the open upper and lower portions. An electric cord which applies an external voltage having a polarity opposite to that of the voltage supplied to the first electrode 220 is distributed to the second electrode 240. Like the first electrode 220, the second electrode 240 has the conical shape with the diameter thereof gradually decreasing in the direction from top to bottom, as well as a shape having the open upper and lower portions, and is configured such that the lower portion is exposed to the lower space 210a of the chamber 210 through a hole which is formed at the center of the partition plate 212. In addition, like the first electrode 220, the second electrode 240 is molded from an alloy that contains at least one selected from among Cu, Ag and Al, and an electric cord through which a voltage is applied from the outside is distributed to the lower portion thereof. In addition, the second electrodes 240 has second water flow guide grooves 241 in the inner surface thereof. The second water flow guide grooves 241 extend in the lengthwise direction, and are arranged at regular distances from each other, such that the water that is supplied to the lower space 210a can efficiently flow in between the first and second electrodes 220 and 240. The second electrode 240 having this configuration is disposed such that the second electrode 240 and the first electrode 220 are concentric with each other, on both sides of the insulation holder 230, which is rotated by the driving source 250. The second electrode 240 receives electric power from the control panel C, and generates ions together with the first electrode 220, so that ions are dissolved into the inflow water.

The vortex driving source 250 is a component which generates the rotary driving force for rotating the insulation holder 230 while causing the water introduced through the inlet pipe to have a vortex flow, so that ions generated by the interaction between the first electrode 220 and the second electrode 240 can be efficiently mixed to the inflow water. The vortex driving source 250 generally includes a rotor support 252, a vortex rotor 251 and the insulating support 253.

The rotor support 252 includes a rotor bracket 252a which has the shape of a concaved vessel such that it surrounds the inlet pipe 211 of the chamber 210, a bearing 252c which is integrally provided on the upper central portion of the rotor bracket 252a, and a rotary sleeve 252b which is a rotary element rotatably coupled to the bearing 252c, and into which a rotary post 251b of the vortex rotor 251, which will be described later, is axially fitted. The rotor bracket has a size such that the periphery thereof receives the inlet pipe 211 of the chamber 210, is fixedly bonded to the inner surface of the chamber 210 via welding, and has through-holes 252s which are formed around the bearing 252c, and through which the water introduced through the inlet pipe 211 can flow into the lower space 210a of the chamber 210. The inner circumference of the rotary sleeve 252b, one of the components of the rotor support 252, is machined to have a repetition of concaves and convexes. The rotary post 251b of the vortex rotor 251, which will be described later, is fitted into and assembled to the rotary sleeve 252b, and also has the corresponding shape.

The vortex rotor 251 includes a screw 251a which is rotated by the inflow water introduced through the inlet pipe 211 of the chamber 210 and the rotary post 251b which is integrally provided on the lower portion of the screw 251a. The rotary post 251b is fitted into and assembled to the rotary sleeve 252b, and is connected to the same such that it can rotate and be displaced in the top-bottom direction. At this time, as shown in the figures, the screw 251a has a plurality of blades each having a spiral groove in the outer circumference thereof. The rotary post 251b can cooperate with and be integrally rotated by the rotary sleeve 252b in the state in which it is fitted into and assembled to the same, and is provided such that it can be displaced in the top-bottom direction. In addition, the vortex rotor 251 has a fastening recess 251h at the upper center thereof, into which the lower end of the insulating support 253, which will be described later, is fixedly fitted.

The insulating support 253 is a connecting member, of which the upper end is connected to the lower portion of the insulation holder 230 and the lower end is connected to the vortex rotor 251. This insulating support 253 includes a plurality of link portions 253a, the upper ends of which are connected to the lower periphery of the open lower portion of the insulation holder 230, and a fastening shaft 253b at which the link portions 253a are connected together. The lower end of the fastening shaft 253b is fixedly fitted into the fastening recess 251h such that the fastening shaft 253b is integrally coupled to the fastening recess 251h. In the vortex driving source 250 having the above-described configuration, the vortex rotor 251 is rotated under the pressure of the inflow water when the water is introduced through the inlet pipe 211 of the chamber 210. The insulation holder 230 connected to the vortex rotor 251 via insulating support 253 cooperates with and is integrally rotated by the vortex rotor 251.

A description will be given below of the operation of the metal ion sterilization device having the above-described configuration according to the second embodiment of the invention. First, when high-pressure water is introduced into the chamber 210 through the inlet pipe 211, the vortex rotor 251 of the vortex driving source 250 is rotated in one direction under the pressure of the inflow water. In addition, the water introduced through the inlet pipe 211 fills up the lower space 210a of the chamber 210 through the through-holes 252s. Part of the filled water flows through the through-holes 212a of the partition plate 212 and flows into the upper space 210b of the chamber 210, whereas the remaining part of the water flows through the gap between the first electrode 220 and the second electrode 240. At this time, the first electrode 220, the second electrode 240 and the insulation holder 230 have the first water flow guide grooves 221, the second water flow guide grooves 241 and the water flow guide slots 231, such that the water can efficiently flow in. At the moment that the water is introduced into the chamber 210, the first electrode 220 and the second electrode 240 are applied with voltages having different polarities and the insulation holder 230 is rotated in one direction under the rotational driving force of the vortex driving source 250. Consequently, ions which are generated by the interaction between the first electrode 220 and the second electrode 240 can be efficiently mixed to the water that flows between the first electrode 220 and the second electrode 240. In an example, when the first electrode 220 is applied with positive (+) polarity and the second electrode 240 is applied with negative (−) polarity, ionization is carried out at the first electrode 220, or the positive (+) electrode. While metal ions ionized in this fashion are being dissolved toward the negative (−) electrode, they are dissolved into the water that flows between the first and second electrodes 220 and 240. Therefore, the water that has flown between the first and second electrodes 220 and 240 contains a large amount of metal ions. This water is mixed with the water that has flown through the through-holes 212a of the partition plate 212 before being discharged through the outlet pipe 213 to the outside. In the meantime, when wear occurs in the first electrode 220 and the second electrode 240, the first electrode 220 is elastically supported by the electrode support 225, in the bottom direction in which the weight is applied. Therefore, when wear occurs in the first electrode 220 and the second electrode 240, the first electrode 220 is forced to move down in the weight direction along the smooth surface of the insulation holder 230 which is coated with the Teflon-based resin having a low coefficient of friction. Consequently, the gap between the first electrode 220 and the second electrode 240 is maintained uniform irrespective of the wear of the electrodes, so that ions can be reliably generated.

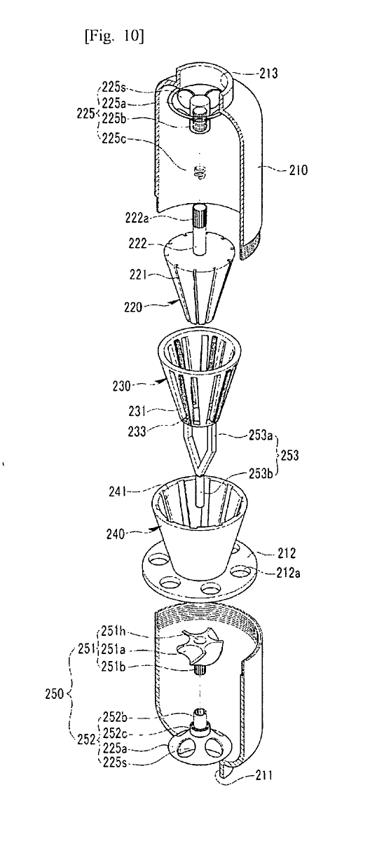

FIG. 10 is an exploded perspective view showing a modified embodiment of FIG. 7. Since the metal ion sterilization device 1 is substantially identical to the former metal ion sterilization device which was described with reference to FIG. 7 and FIG. 8, the same components will be designated with the same reference numerals and descriptions thereof will be omitted. The technical features of this embodiment are to remove nanoparticles that are attached to the first and second electrodes 220 and 240 during the ionization process, thereby reliably maintaining the performance of generating ions while increasing the ease of maintenance and the reliability of the performance of products. For this, this embodiment proposes a construction in which brushes 233 are integrally provided in the insulation holder 230 disposed between the first and second electrodes 220 and 240. Each of the brushes 233 can be implemented by forming bristles from a synthetic resin or an insulating material or forming a synthetic resin or an insulating material in the shape of strips. In addition, the insulation holder 230 has brush holes (no reference numeral) which arranged at regular distances. The brush holes are formed at positions that do not interfere with the positions of the water flow guide slots 231, and the brushes 233 are fitted into the brush holes such that the brushes 233 can be securely mounted. The insulation holder 230 having the above-described configuration cooperates with and is integrally rotated by the vortex driving source 250. At this time, the plurality of brushes 233 provided in the vortex driving source 250 rotates while frictionally abutting against the first and second electrodes 220 and 240, which are provided inside and outside the insulation holder 230, thereby removing the nanoparticles, scale or the like attached to the first and second electrodes 20 and 40.

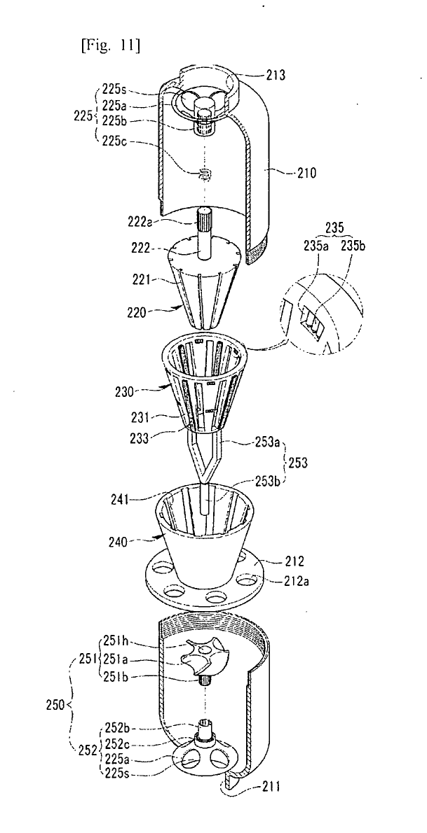

FIG. 11 is an exploded perspective view showing another modified embodiment of FIG. 7. The technical features of this embodiment are to propose rolling elements 235 which are in rolling contact with the first and second electrodes 220 and 240 so that the insulation holder 230 which rotates by receiving the driving force from the vortex driving source 250 efficiently rotates or has a proper displacement in the top-bottom direction with respect to the inside and outside electrodes. For this, this embodiment proposes a construction which has installation holes 235a, which are formed at positions that interfere with neither the water flow guide slots 231 nor the brushes 233, and rollers 235b, or the rolling elements, which are rotatably provided in the installation holes 235a. Here, the rollers 235b can be substituted with balls, or spheres, and can be disposed such that they roll with respect to the direction in which the insulation holder 230 rotates or with respect to the displacement of the first and second electrodes 220 and 240 in the top-bottom direction.

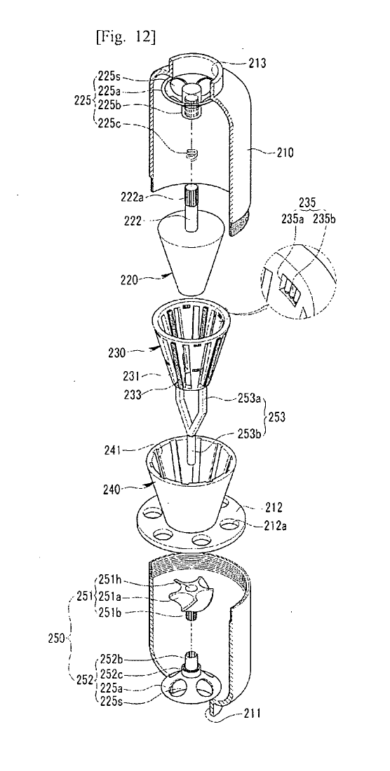

FIG. 12 shows a further modified embodiment of FIG. 7. The technical features of this embodiment are to propose a construction in which only the second water flow guide grooves 241 and the water flow guide slots 231 are formed in the second electrode 240 and the insulation holder 230 without the first water flow guide grooves 221 in the outer surface of the first electrode 220.

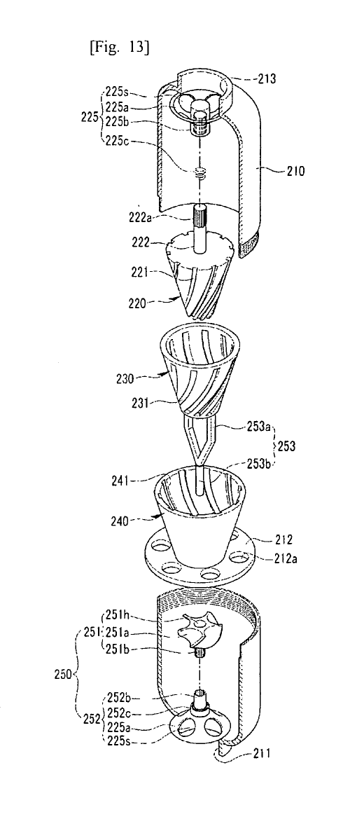

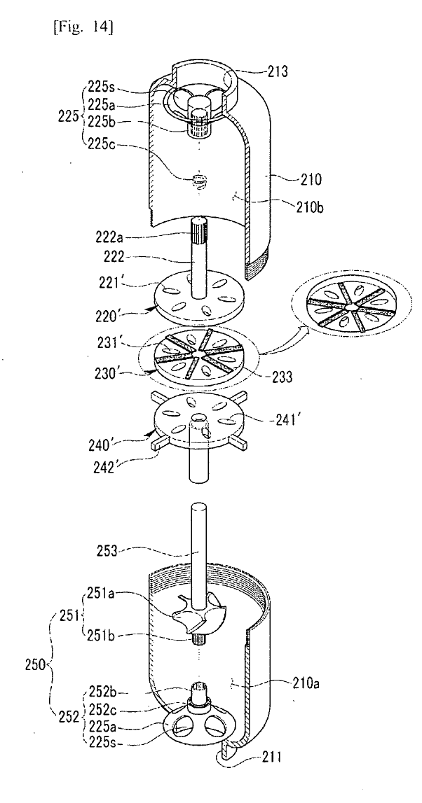

FIG. 13 shows further another modified embodiment of FIG. 7. This embodiment proposes addition of vortex elements. When the insulation holder 230 rotates, the vortex elements properly guide the water, which is supplied to the lower space 210a, between the first and second electrodes 220 and 240 so that the water is ionized, and cause the water, which has flown through the first and second electrodes 220 and 240, to create a vortex flow. Consequently, the water can be efficiently mixed with the water that has flown into the upper space 210b through the through-holes 212a of the partition plate 212. For this, according to this embodiment, the first water flow guide grooves 221, the second water flow guide grooves 241 and the water flow guide slots 231 have a spiral shape which can cause a vortex flow, unlike the linear shape of the former embodiments.

FIG. 13 is an exploded perspective view showing another modified embodiment of FIG. 7. According to the technical features of this embodiment, each of a first electrode 220′, a second electrode 240′ and an insulating holder 230′ positioned between the first and second electrode 220′ and 240′ has the shape of a disk. The first electrode 220′ has a support post 222 which extends from the upper central portion in the top-bottom direction, which is connected to an electrode support 225. First water flow guide holes 221′ are formed in the first electrode 220′, and are radially disposed.

The second electrode 240′ has a through-hole (no reference numeral) at the center thereof, through which the insulating support 253 of the vortex driving source 250 can pass without interference when it is fitted into the through-hole. One end of each of connecting pieces 242′ is connected to the outer circumference of the second electrode 240′. With the connecting pieces 242′, the second electrode 240′ is fixed to the inner surface of the chamber 210. Like the first electrode 220′, a plurality of water flow guide holes 241′ is formed in the top-bottom direction.

The insulating holder 230′ is positioned between the first electrode 220′ and the second electrode 240′, and is integrally assembled to the insulating support 253 of the vortex driving source 250. The insulating holder 230′ is configured such that it rotates in one direction in cooperation with the vortex driving source 250. Like the former embodiments, the insulating holder 203′ has a plurality of brushes 233 and a plurality of water flow guide holes 230′ between the brushes 233.

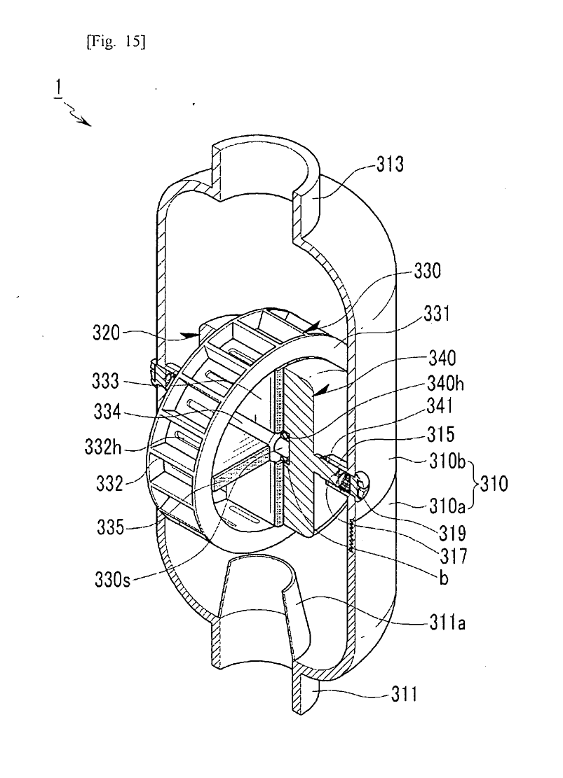

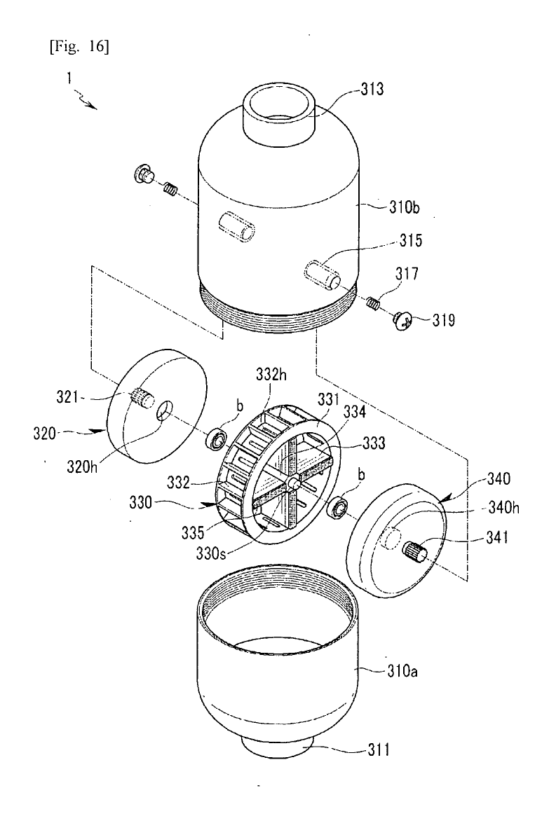

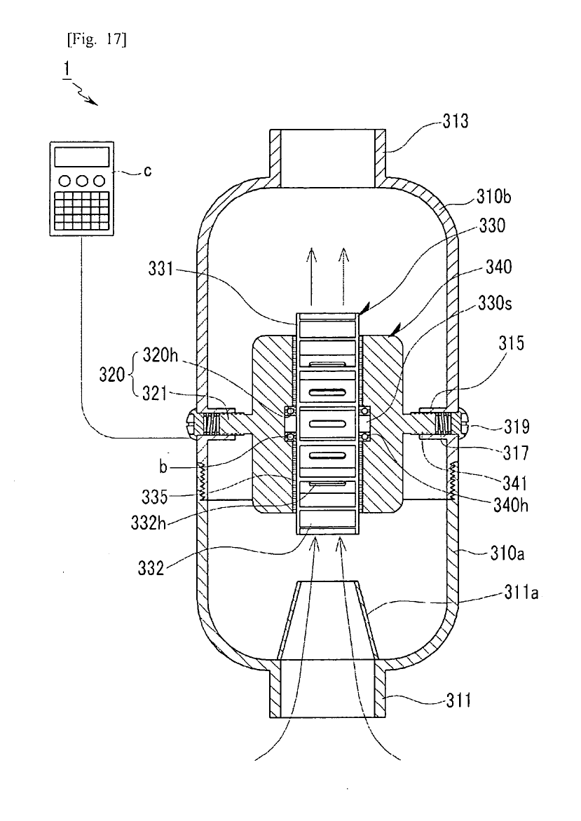

FIG. 15 to FIG. 17 are views depicting a metal ion sterilization device according to a third embodiment of the invention. The metal ion sterilization device 31 according to this embodiment includes a chamber 310 having a channel in which water introduced from the outside contains metal ions therein and through which the water flows to the outside; first and second electrodes 320 and 340 which are disposed inside the chamber 310 to receive external voltages, are fixedly disposed in the chamber 310 such that they are prevented from rotating, and are applied with elastic supporting forces in opposing directions; and an insulation mill 330 which is disposed between the first and second electrodes 320 and 340 to insulate between the first and second electrodes 320 and 340, and is rotated like a water mill under the pressure of the inflow water.

As shown in the figures, the chamber 310 is a hollow tubular member, and has an inlet pipe 311 in the lower portion thereof through which the water can be introduced and an outlet pipe 313 in the upper portion thereof through which the introduced water can be discharged to the outside. Since the inlet pipe 311 and the outlet pipe 313 serve to as passages through which the water is introduced and the ionized water into which ions are dissolved is discharged, the positions thereof can be variously modified. In the meantime, according to the invention, the chamber 310 is configured such that an inlet housing 310a which has the inlet pipe 311 and a discharge housing 310b which has the outlet pipe 313 are assembled to each other via screw fastening. Inside the chamber 310, support pipe portions 315 which fixedly support the first and second electrodes 320 and 340, which will be described later, protrude in the direction toward each other. In addition, the support pipe portions 315 are closed outside the chamber 310 by finishing members 319. The finishing members 319 can be implemented as screw members which are coupled to the support pipe portions 315 via screw fastening. In addition, since electric cords through which electric power is supplied are connected to the finishing members 319, it is preferred that the finishing members 319 be molded from a metal. A packing can be added in order to maintain the inside of the chamber 310 watertight. Reference numeral 311a which has not been described refers to a guide pipe. The guide pipe 311a enables the water that is introduced through the inlet pipe 311 to be supplied to the insulation mill 330 at a high pressure, and as shown in the figure, is configured such that its diameter gradually decreases in the direction toward the insulation mill 330. The chamber 310 having this configuration can be molded from a material selected from among a synthetic resin, a stainless steel, an alloy and the like. It is preferred that the chamber 310 be made of an insulating material that is corrosion resistant and chemical resistant.

The first and second electrodes 320 and 340 are disk-shaped members, which are disposed on both sides of the insulation mill 330, which will be described later. The first and second electrodes 320 and 340 are electrically wired such that they are supplied with voltage having different polarities, and are controlled by the control panel c shown in FIG. 4, which is electrically connected thereto. The first electrode 320 and the second electrode 340 are molded from an alloy that contains at least one selected from among Cu and Ag. Both of the first and second electrodes 320 and 340 can be molded from the same metal, or the first and second electrodes 320 and 340 can be molded from different metals. The first and second electrodes 320 and 340 are configured such that they are elastically supported in the direction toward the insulation mill 330, which will be described later, when wear occurs. Consequently, a uniform gap between the first and second electrodes 320 and 340 is maintained irrespective of the wear of the electrodes. For this, according to the invention, the first electrode 320 has a first fixed shaft 321 which protrudes from the center of one side thereof, the second electrode 340 has a second fixed shaft 341 which protrudes from the center of one side thereof, and coil springs 317 made of metal are provided inside the support pipe portion 315, such that the first and electrodes 320 and 340 can be axially slid and be fitted into the support pipe portions 315 so that they do not rotate. Specifically, the first and second fixed shafts 321 and 341 have a concave-convex structure (no reference numeral) in the outer circumference thereof, whereas the supporting pipe portions 315 have a concave-convex structure (no reference numeral) in the inner circumference thereof, which meshes with that of the first and second fixed shafts 321 and 341. The springs 317 made of a conductive metal are provided in the supporting pipe portions 315 such that the first electrode 320 having the first fixed shaft 321 and the second electrode 340 having the second fixed shaft 341 are elastically supported in the direction toward each other. Due to this configuration, the first and second electrodes 320 and 340 stay in close contact with the insulation mill 330, which will be described later, so that a gap that occurs when the electrodes are worn can be compensated for. This consequently maintains a uniform gap to the insulation mill 30, thereby making it possible to reliably generate ions. In the meantime, the first electrode 320 has a first insertion recess 320h in the other side opposite the first fixed shaft 321, and the second electrode 340 has a second insertion recess 340h in the other side opposite the second fixed shaft 341. A rotary shaft 330s of the insulation mill 330, which will be described later, is rotatably inserted into the first and second insertion groove 320h and 340h.

The insulation mill 330 is disposed inside the chamber 310 such that it is rotated by the pressure of the inflow water. The insulation mill 330 is a component that serves to insulate the first and second electrodes 320 and 340 from each other so that they do not directly contact each other, and includes a body 331, a central pipe portion 334 and brushes 335.

The body 331 has a hollow tubular shape, and includes a plurality of blades 332 and a plurality of water passage holes 332h in the circumference thereof, the water passage holes 332h alternating with the blades. The inflow water that is introduced through the inlet pipe 311 of the chamber 310 collides against the blades 332. Part of the inflow water that is introduced through the inlet pipe 311 can flow in through the water passage holes 332h, or the water that has flown in can flow out through the water passage holes 332h.

The central pipe portion 334 is a tubular component that is disposed at the center inside the body 331, and is fixed to the body 331 using the brushes 335, which are disposed on both sides thereof. The rotary shaft 330s, which is to be inserted into the first and second insertion recesses 320h and 340h in the first and second electrodes 320 and 340, protrudes from both ends of the central pipe portion 334. Here, it is preferred that the rotary shaft 330s inserted into the first and second insertion recesses 320h and 340h be supported by a bearing b such that it can be smoothly rotated in this state.

The brushes 335 are radially disposed about the central pipe portion 334. One end of each of the brushes 335 is connected to the central pipe portion 334, and the other end of each of the brushes 335 is connected to the body 331. The brushes 335 serve to remove impurities through frication contact with the first and second electrodes 320 and 340. Each of the brushes 335 can be implemented by forming bristles from a synthetic resin or an insulating material or forming a synthetic resin or an insulating material in the shape of strips. The plurality of brushes 335 frictionally abuts against the first and second electrodes 320 and 340, which are provided on both sides of the insulation mill 330, and removes the nanoparticles, scale or the like attached to the first and second electrodes 320 and 340 following the rotation of the insulation mill 330. Reference numeral 330, which has not been described, indicates partition plates which are radially disposed inside the insulation mill 330, and divide the inner space of the insulation mill 330. The partition plates 333 are provided to divide the inner space of the body 331 in order to prevent the water that is introduced through the water passage holes 332h from remaining in the inner space. In addition, it is preferred that the insulation mill 330 according to the invention be molded from Teflon or an insulating material coated with Teflon. Herein, Teflon indicates a high-molecular compound referred to as a fluorine resin, and is a polymer of unit components which include major components of fluorine, carbon and hydrogen form. The invention proposes providing the insulation mill 330 by molding from such a Teflon material, or by forming an insulation holder from an insulating material, such as a synthetic resin or a ceramics, and then forming a film on its surface using a fluorine resin as a paint.

A description will be given below of the operation of the metal ion sterilization device having the above-described configuration according to the third embodiment of the invention. First, when high-pressure water is introduced into the chamber 310 through the inlet pipe 311, the insulation mill 330, which is designed in the shape of a water mill, is rotated under the pressure of the inflow water. Part of the inflow water that collides against the blades 332 of the insulation mill 330 flows into the body 331 of the insulation mill 330 through the water passage holes 332h. In addition, at the moment that the water is introduced into the chamber 310, the first electrode 320 and the second electrode 340 are applied with voltages having different polarities, thereby generating ions. Ions that are generated are mixed to the water that has flown into the body 331.

In an example, when the first electrode 320 is applied with positive (+) polarity and the second electrode 340 is applied with negative (−) polarity, ionization is carried out at the first electrode 320, or the positive (+) electrode. While metal ions ionized in this fashion are being dissolved toward the negative (−) electrode, they are dissolved into the water that has flown into the space between the first and second electrodes 320 and 340, i.e. the water that has flown into the body 331 of the insulation mill 330. Therefore, ionized water that contains a large amount of metal ions is generated inside the insulation mill 330, i.e. the space between the first and second electrodes 320 and 340. The ionized water created in this fashion is discharged to the outside through the water passage holes 332h, and is then mixed again with the water that is inside the chamber 310 before being discharged to the outside through the outlet pipe 313 by a circular flow created by the insulation mill 330. In the meantime, the first and second electrodes 320 and 340 are elastically supported in the direction toward the insulation mill 330 by the springs 317. When the electrodes are worn, the electrodes are displaced in the direction toward the insulation mill 330 as much as the amount of the electrodes that have been worn by the elastic force of the springs 317. Consequently, the uniform gap between the first and second electrodes 320 and 340 is maintained, so that ions can be reliably generated.

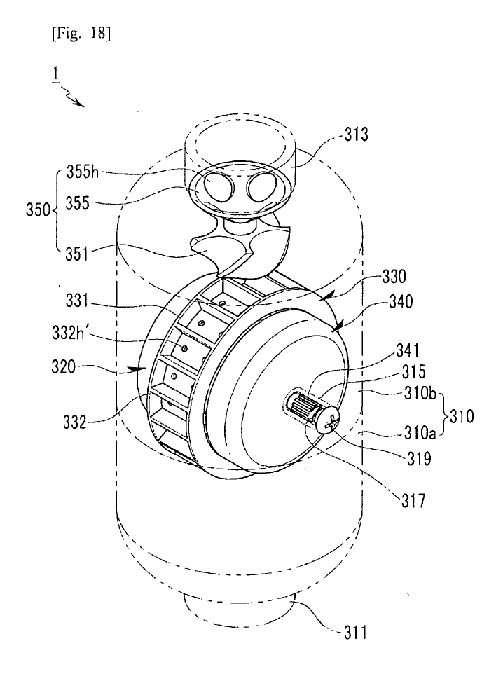

FIG. 18 is a perspective view showing a modified embodiment of FIG. 15. According to the technical features of this embodiment, vortex-creating means 350 are added, which increase the mixing ratio of water when ionized water inside the chamber 310 is discharged to the outside through the outlet pipe 313. The vortex-creating means 350 generally include a bracket 355 and a screw 351 which is rotatably provided on the bracket 355.

The bracket 355 is a member which is positioned inside the chamber 310, and is connected to the outlet pipe 313. The bracket 355 has discharge holes 355h which allow the ionized water inside the chamber 310 to be discharged to the outside through the outlet pipe 313.

The screw 351 is intended to increase the mixing ratio of ions into the water that is introduced into the chamber 310. Describing its configuration, a spiral groove or a spiral blade is formed in or on the outer surface. The screw 351 is rotated by a flow in which the water introduced through the inlet pipe 311 flows through the insulation mill 330 and is then discharged through the outlet pipe 313. It is preferred that the screw 351 be disposed rotatably about the bracket 355. For this, according to the invention, a rotary member 353 is disposed in the connecting portion between the screw 351 and the bracket 355. Here, the rotary member 353 is implemented as a bearing.

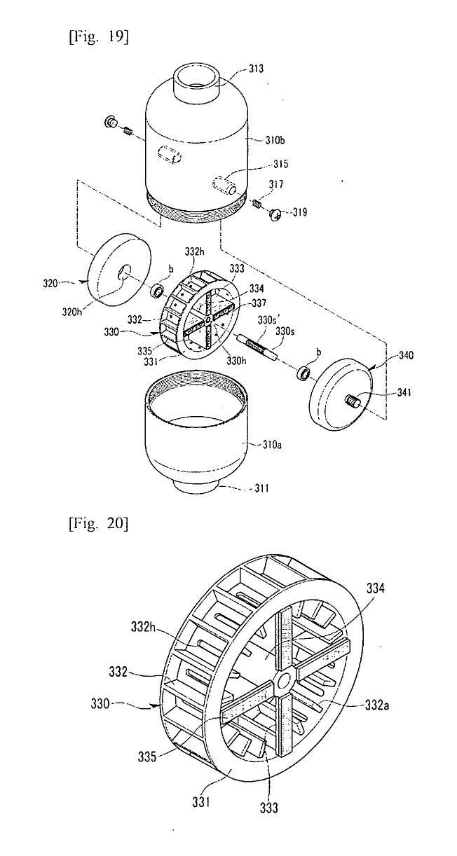

FIG. 19 is an exploded perspective view showing another modified embodiment of FIG. 15. According to the technical features of this embodiment, rolling elements 337 are proposed. The rolling elements 337 enable the insulation mill 330 to smoothly rotate with respect to the first and second electrodes 320 and 340 under the pressure of the inflow water introduced into the chamber 310. For this, according to this embodiment, the insulation mill 330 also has the rolling elements 337 configured as rolling members in addition to the brushes 335. The rolling elements 337 are configured as balls, rollers or a low-friction material such that they come into a point contact with the first and second electrodes 320 and 340. As shown in FIG. 9, a plurality of rolling elements 337 are provided at positions where their turning paths do not interfere with each other.

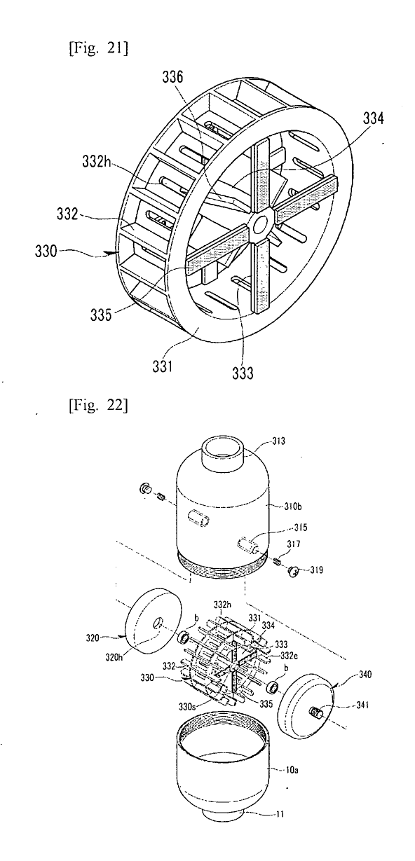

FIG. 20 to FIG. 22 are perspective views showing a modified embodiment of the insulation mill shown in FIG. 15. The insulation mill 330 is illustrated as having a plurality of auxiliary blades 332a protruding from the inner circumference thereof. The auxiliary blades 332a are arranged at distances from each other. Here, the auxiliary blades 332a extend from the blades 332. FIG. 21 proposes a spiral screw 336 as a component for creating a vortex flow that helps the ionized water staying inside the insulation mill 330 be rapidly discharged from the insulation mill 330. The spiral screw 336 includes blades which are spirally arranged with respect to the central pipe portion 334. The spiral screw 336 helps the water or ionized water contained inside the body 331 of the insulation mill 330 have a rapid vortex flow, thereby increasing the efficiency at which the water and the ionized water are mixed. In addition, the mixed ionized water can be easily discharged from the body 331 of the insulation mill 330 by the rapid vortex flow. Finally, FIG. 22 shows a construction in which extension blades 332e are formed by extending the blades 332 of the insulation mill 330 in the direction toward the circumference of the first and second electrodes 320 and 340. The blades 332 and the extension blades 332e provide a wider area which is under the pressure of the inflow water introduced through the inlet pipe 311, thereby improving the rotation of the insulation mill 330.

The present invention is not limited to the foregoing embodiments, but can be changed in forms and details. It should therefore be understood that such modifications and variations fall within the scope of the claims of the invention.

1. A metal ion sterilization device comprising:
a chamber having a channel through which water passes;
a conical first electrode disposed in the channel of the chamber to receive an external voltage, with a diameter thereof gradually decreasing in a direction from top to bottom;
an insulation holder having an expanded conical shape to enable the first electrode to be inserted and held therein, one portion of the insulation holder being connected to a driving source so as to be rotatable;
a second electrode having an expanded conical shape to enable the insulation holder to be inserted and held therein, the second electrode receiving an external voltage having a polarity opposite to a polarity of the first electrode; and
a brush disposed in a direction perpendicular to the insulation holder, and abutting against outer and inner surfaces of the first and second electrodes.

2. The metal ion sterilization device of claim 1, wherein at least one of the first and second electrodes has water flow guide grooves in an outer surface and an inner surface thereof, the water flow guide grooves extending in a lengthwise direction, and the insulation holder has water flow guide slots corresponding to the water flow guide grooves.

3. The metal ion sterilization device of claim 1,
wherein the chamber comprises a lower space to which an inlet pipe through which the water is introduced from an outside is connected and an upper space partitioned from the lower space, an outlet pipe through which the water is discharged to the outside being connected to the upper space,
wherein a lower portion of the second electrode is seated in a seating portion which comprises a through-hole in the partition plate, and
wherein a lower portion of the first electrode protrudes in top-bottom direction through a bottom of the chamber, the first electrode being connected to and supported by an upper end of a support post to which an electric cord connected to the first electrode is distributed, and a portion of the support post which passes through a bottom plate of the chamber being support by a waterproof seal such that the support post is displaceable in the top-bottom direction.

4. The metal ion sterilization device of claim 1, wherein the insulation holder comprises a Teflon material or an insulating material coated with Teflon.

5. The metal ion sterilization device of claim 1, wherein the driving source comprises:
a driving motor provided outside and above the chamber to generate a rotational driving force;
a motor waterproof seal surrounding and supporting a rotary shaft of the driving motor which extends through an upper plate of the chamber such that the rotary shaft is movable in the top-bottom direction; and
a link body, one end of the link body being connected to a distal end of the rotary shaft which is positioned inside the chamber, the other end of the link body being divided into two or more branches, which are connected to upper peripheries of the insulation holder at predetermined distances.

6. The metal ion sterilization device of claim 1, wherein the insulation holder comprises a rolling element which is in rolling contact with the first and second electrodes.

7. The metal ion sterilization device of claim 2, wherein the water flow guide grooves and the water flow guide slots are formed linearly, or are formed spirally such that a vortex flow is caused.

8. The metal ion sterilization device of claim 1, wherein the first and second electrodes comprise an alloy that contains at least one selected from among copper (Cu+), silver (Ag+) and aluminum (Al).

9. A metal ion sterilization device for generating ionized water by dissolving metal ions into water supplied from an outside, the metal ion sterilization device comprising:
a chamber (210) having an inlet pipe (211) and an outlet pipe (213);
a conical first electrode (220) disposed inside the chamber (210) to receive an external voltage, with a diameter thereof gradually decreasing in a direction from top to bottom, a portion of an upper part of the first electrode being supported by a portion of an inner part of the chamber (210);
an insulation holder (230) having an expanded conical shape such that the first electrode (220) is inserted and held therein, and is rotatable;
a second electrode (240) having an expanded conical shape such that the insulation holder (230) is inserted and held therein, the second electrode receiving an external voltage having a polarity opposite to a polarity of the first electrode (220); and
a vortex driving source (250) connected to a portion of the lower part of the insulation holder (230) to rotatably support the insulation holder (230), the vortex driving source being rotated by the water that is introduced thereto.

10. A metal ion sterilization device for generating ionized water by dissolving metal ions into water supplied from an outside, the metal ion sterilization device comprising:
a chamber (210) having an inlet pipe (211) through which the water is introduced and an outlet pipe (213) through which the water is discharged to the outside;
a first electrode (220′) having a disk shape, and disposed inside the chamber (210) to receive an external voltage, a portion of an upper part thereof being supported by a portion of an inner part of the chamber (210);
an insulation holder (230′) having a disk shape, and provided at a portion of the first electrode (220′), the insulation holder rotating by receiving a rotational driving force; a second electrode (240′) facing the first electrode (220′), with the insulation holder (230′) being interposed therebetween, the second electrode receiving an external voltage having a polarity opposite to a polarity of the first electrode (220′); and
a vortex driving source (250) connected to a portion of a lower part of the insulation holder (230) to rotatably support the insulation holder (230), the vortex driving source being rotated by the water that is introduced thereto.

11. The metal ion sterilization device of claim 9, wherein at least one of the first and second electrodes (220, 240) has water flow guide grooves in an outer surface and an inner surface, the water flow guide grooves extending in a lengthwise direction, and the insulation holder (230) has water flow guide slots (231) corresponding to the water flow guide grooves.

12. The metal ion sterilization device of claim 9, wherein the chamber (210) comprises an upper space (210b) and a lower space (210a) by a partition plate (212) which has a through-hole therein, the upper space (210b) being connected to the outlet pipe (213) through which the water is discharged, the lower space (210a) being connected to the inlet pipe (211) through which the water is introduced.

13. The metal ion sterilization device of claim 9, wherein the first electrode comprises:
a support post (222) protruding from an upper central portion in a top-bottom direction, the support post having a concave-convex fitting portion (222a) at a distal end thereof; and
an electrode support (225) disposed above the support post (222) and integrally fixed to the outlet pipe (213) of the chamber (210), the electrode support comprises:
an electrode bracket (225a) having a through-hole (225s) which allows the water to flow through;
an electrode sleeve (225b) protruding from a lower portion of the electrode bracket (225a), an upper portion of the support post (222) being fitted and inserted into the electrode sleeve to support the electrode sleeve so as to be movable in the top-bottom direction; and
an elastic body (225c) provided inside the electrode sleeve (225b) to apply an elastic supporting force to the support post (222).

14. The metal ion sterilization device of claim 9, wherein the insulation holder comprises brushes (233) which removes impurities by frictionally abutting against outer and inner surfaces of the first and second electrodes.

15. The metal ion sterilization device of claim 9, wherein the vortex driving source (250) comprises:
a rotor support (252) including a rotor bracket (252a) provided at one portion of the inlet pipe (211) and having a through-hole (252s) and a rotary sleeve (252b) rotatably provided above the rotor bracket (252a) and having a concave-convex structure in an inner circumference thereof;
a vortex rotor (251) including a screw (251a) which is rotated by the water introduced through the inlet pipe (211) and a rotary post (251b) which is integrally provided on the lower portion of the screw 251a and is meshed into the rotary sleeve (252b) so as to be rotatable and displaceable in a top-bottom direction; and
an insulating support (253), an upper end of the insulating support being connected to a portion of a lower part of the insulation holder, a lower end of the insulating support being connected to the vortex rotor (251).

16. The metal ion sterilization device of claim 9, wherein the insulation holder comprises rolling elements (235) which are in rolling contact with the first and second electrodes.

17. The metal ion sterilization device of claim 11, wherein the water flow guide grooves and the water flow guide slots are formed linearly, or are formed spirally such that a vortex flow is caused.

18. The metal ion sterilization device of claim 9, wherein the first and second electrodes comprise an alloy which contains at least one of copper (Cu+) and silver (Ag+), and the insulation holder comprises a Teflon material or an insulating material coated with Teflon.

19. A metal ion sterilization device for generating ionized water by dissolving metal ions into water supplied from an outside, in which a pair of electrodes are disposed on both sides of an insulator, the metal ion sterilization device comprising:
a chamber (310) having an inlet pipe (311) and an outlet pipe (313);
an insulation mill (330) disposed inside the chamber (310) to be rotated by the water that is introduced thereto, the insulation mill having a hollow tubular shape, having both open sides, and being made of an insulating material, and including a plurality of blades (332) provided on a circumference thereof and water passage holes (332h); and
the first and second electrodes (320, 340) being fixedly provided on both sides of the insulation mill (330), having a shape of a disk, and receiving different voltages from an outside.

20. The metal ion sterilization device of claim 19,
wherein the chamber (310) comprises a pair of hollow support pipe portions (315) which protrude into the chamber so as to face each other and finishing members (319) which close the support pipe portions (315) via screw fastening, and are made of a metal, an electric cord being connected to the finishing members,
wherein the first and second electrodes (320, 340) are fitted into the support pipe portions (315) so as not to rotate, and comprise first and second fixed shafts (321, 341) which are made of a metal so as to receive a voltage and first and second insertion recesses (320h, 340h) in central portions opposite the first and second fixed shafts,
wherein the insulation mill (330) has a rotary shaft (330s) protruding from both central portions thereof, the rotary shaft being rotatably fitted into the first and second insertion recesses (320h, 340h), and
wherein the support pipe portions (315) have metal springs (317) therein, the springs elastically pressing the first and second fixed shafts (321, 341) to support the first and second electrodes (320, 340) so as to closely abut against the insulation mill (330).

21. The metal ion sterilization device of claim 19, wherein the insulation mill (330) comprises brushes (335) which are radially disposed on both sides thereof, the brushes frictionally abutting against the first and second electrodes (320, 340), thereby removing impurities therefrom.

22. The metal ion sterilization device of claim 19, wherein insulation mill (330) comprises a tubular body (331) having blades (332) and water passage holes (332h) in a circumference thereof, a central pipe portion (334) disposed in an central portion of the body (331), a rotary shaft 330s protruding from both ends of the body, and brushes (335) disposed on both sides of the body and radially connected to the central pipe portion.

23. The metal ion sterilization device of claim 19, wherein the first and second electrodes comprise an alloy which contains at least one of copper (Cu+) and silver (Ag+), and the insulation holder comprises a Teflon material or an insulating material coated with Teflon.

24. The metal ion sterilization device of claim 19, wherein the insulation mill (330) further comprises a plurality of partition plates (333) which are radially disposed inside the insulation mill to divide an inner space thereof.

25. The metal ion sterilization device of claim 19, wherein the chamber (310) further comprises vortex-creating means (350) disposed inside the chamber, for causing a vortex flow in the water that is discharged, the water containing ions, wherein the vortex-creating means include:
a bracket (355) having one end of the bracket connected to the outlet pipe (313) and a discharge hole (355h) which allows ionized water to be discharge through the outlet pipe (313); and
a screw (351) rotatably connected to one end of the bracket (355), wherein the screw is rotated by a flow of the ionized water when the insulation mill (330) below the screw is rotated.

26. The metal ion sterilization device of claim 19, wherein the insulation mill (330) comprises a plurality of auxiliary blades (332a) which protrude from the inner circumference and are arranged at predetermined distances and/or extension blades (332e) which are formed by extending the blades (332) toward circumferences of the first and second electrodes (320, 340).

27. The metal ion sterilization device of claim 21, wherein the brushes (335) further comprise rolling elements (337) which are in rolling contact with the first and second electrodes (320, 340).

28. The metal ion sterilization device of claim 22, wherein the central pipe portion (334) has a spiral screw (336) having spiral blades, the spiral screw being rotatable to create a flow of the water so as to be guided and discharged outside the insulation mill (330).

29. The metal ion sterilization device of claim 10, wherein the chamber (210) comprises an upper space (210b) and a lower space (210a) by a partition plate (212) which has a through-hole therein, the upper space (210b) being connected to the outlet pipe (213) through which the water is discharged, the lower space (210a) being connected to the inlet pipe (211) through which the water is introduced.

30. The metal ion sterilization device of claim 10, wherein the first electrode comprises:
a support post (222) protruding from an upper central portion in a top-bottom direction, the support post having a concave-convex fitting portion (222a) at a distal end thereof; and
an electrode support (225) disposed above the support post (222) and integrally fixed to the outlet pipe (213) of the chamber (210), the electrode support comprises:
an electrode bracket (225a) having a through-hole (225s) which allows the water to flow through;
an electrode sleeve (225b) protruding from a lower portion of the electrode bracket (225a), an upper portion of the support post (222) being fitted and inserted into the electrode sleeve to support the electrode sleeve so as to be movable in the top-bottom direction; and
an elastic body (225c) provided inside the electrode sleeve (225b) to apply an elastic supporting force to the support post (222).

31. The metal ion sterilization device of claim 10, wherein the insulation holder comprises brushes (233) which removes impurities by frictionally abutting against outer and inner surfaces of the first and second electrodes.

32. The metal ion sterilization device of claim 10, wherein the vortex driving source (250) comprises:
a rotor support (252) including a rotor bracket (252a) provided at one portion of the inlet pipe (211) and having a through-hole (252s) and a rotary sleeve (252b) rotatably provided above the rotor bracket (252a) and having a concave-convex structure in an inner circumference thereof;
a vortex rotor (251) including a screw (251a) which is rotated by the water introduced through the inlet pipe (211) and a rotary post (251b) which is integrally provided on the lower portion of the screw 251a and is meshed into the rotary sleeve (252b) so as to be rotatable and displaceable in a top-bottom direction; and
an insulating support (253), an upper end of the insulating support being connected to a portion of a lower part of the insulation holder, a lower end of the insulating support being connected to the vortex rotor (251).

33. The metal ion sterilization device of claim 10, wherein the insulation holder comprises rolling elements (235) which are in rolling contact with the first and second electrodes.

34. The metal ion sterilization device of claim 10, wherein the first and second electrodes comprise an alloy which contains at least one of copper (Cu+) and silver (Ag+), and the insulation holder comprises a Teflon material or an insulating material coated with Teflon
